(19) United States
(12) Patent Application Publication
(10) Pub. No.: US 2024/0333606 A1
(43) Pub. Date: Oct. 3, 2024

(54) APPLICATION AWARE HIGH AVAILABILITY CLUSTER

(71) Applicant: INTERNATIONAL BUSINESS MACHINES CORPORATION, ARMONK, NY (US)

(72) Inventors: GEORG BASIL RICHARD MOSHOUS, UNTERFOHRING (DE); ADRIANA PELLEGRINI FURNIELIS, VALINHOS (BR); SARVESH S. PATEL, PUNE (IN); MARC HENRI COQ, HOPEWELL JUNCTION, NY (US); EBENEZER KOFI, DULUTH, GA (US)

(21) Appl. No.: 18/192,442

(22) Filed: Mar. 29, 2023

(51) Int. Cl. H04L 41/5009; H04L 41/14; H04L 41/5025

(52) U.S. Cl. CPC H04L 41/5009; H04L 41/145; H04L 41/5025

(57) ABSTRACT

Optimizing non-functional requirements across components of a high availability cluster may include receiving metadata from each of a plurality of components of a high availability network cluster. The metadata is indicative of a value, measured by each of the plurality of components, of one or more non-functional requirements of a service level agreement (SLA) associated with an application. A predicted non-functional requirement is calculated using the metadata based on a model. The model is trained to determine the predicted non-functional requirement based on relationships between the metadata of each of the plurality of components. A potential violation of the SLA is determined based on a comparison of the predicted non-functional requirement and the metadata.

### BACKGROUND

### Field of the Disclosure

The field of the disclosure is high availability clusters, or, more specifically, methods, apparatus, and products for optimizing non-functional requirements across components of a high availability cluster.

### Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

High availability (HA) clusters are groups of computers that support server applications in which HA software is used to implement redundant system components in groups or clusters that provide continued service when one or more of the system components fail. Accordingly, HA clusters are used to ensure that an application can sustain failing components, be it a software component or a hardware component. The dominant approach is to build a high available solution which is able to sustain a Single Point of Failure of a functional component. Checks are performed to determine that the software components are running and responding as well as to determine that also the hardware is functional. In a clustered environment, the hardware components are available redundantly so that the high availability system can switch over to a redundant part if one part is detected as failed.

One typical HA implementation approach is to have an active-active approach in which an application is run on all redundant hardware components at the same time, and in case of a component failure, the application will continue to run on the remaining parts. Another typical HA implementation approach is an active-passive approach in which the application is run on a primary set of components and will switch to a redundant set of components in case the primary set of components experiences an issue. Both implementation approaches deal with functional availability of the application, meaning providing the functions necessary to implement the application. In many cases, it is nearly as important for an application to deliver non-functional requirements associated with an application that relate to the performance of the components in providing the services of the application, such as transaction latencies. However, existing high availability cluster management approaches do not factor in these non-functional requirements.

### SUMMARY

An embodiment of a method for optimizing non-functional requirements across components of a high availability cluster includes receiving metadata from each of a plurality of components of a high availability network cluster, the metadata indicative of a value, measured by each of the plurality of components, of one or more non-functional requirements of a service level agreement (SLA) associated with an application. The method further includes calculating a predicted non-functional requirement using the metadata based on a model, the model being trained to determine the predicted non-functional requirement based on relationships between the metadata of each of the plurality of components. The method further includes determining a potential violation of the SLA based on a comparison of the predicted non-functional requirement and the metadata.

In some embodiments, the method further includes identifying one or more components of the plurality of components contributing to the potential violation. In some embodiments, the method further includes requesting information associated with the potential violation from the one or more identified components; receiving the requested information from the one or more identified components; and determining one or more mitigation actions based on the received information. In some embodiments, the method further includes initiating the one or more mitigation actions.

In some embodiments, initiating the one or more mitigation actions comprises sending a request to one or more of the plurality of components to modify an operation of the component to improve fulfillment of the SLA.

In some embodiments, the method further includes determining an expected improvement to the predicted non-functional requirement for each of the one or more mitigation actions using the model; ranking the one or more mitigation actions based on the respective expected improvement to the predicted non-functional requirement; selecting one of the mitigation actions based on the ranking; and initiating the selected mitigation action.

In some embodiments, the metadata further includes a health status associated with each of the plurality of components. In some embodiments, the one or more non-functional requirements includes one or more of a latency or bandwidth associated with each of the plurality of components. In some embodiments, the one or more components include at least one of a database, a server, an operating system component, a storage area network (SAN), and a storage subsystem.

An embodiment of an apparatus for optimizing non-functional requirements across components of a high availability cluster includes: a computer processor; and a computer memory operatively coupled to the computer processor, the computer memory having disposed within it computer program instructions that, when executed by the computer processor, cause the apparatus to: receive metadata from each of a plurality of components of a high availability network cluster, the metadata indicative of a value, measured by each of the plurality of components, of one or more non-functional requirements of a service level agreement (SLA) associated with an application. The apparatus is further caused to calculate a predicted non-functional requirement using the metadata based on a model, the model being trained to determine the predicted non-functional requirement based on relationships between the metadata of each of the plurality of components; and determine a potential violation of the SLA based on a comparison of the predicted non-functional requirement and the metadata.

An embodiment of a computer program product for optimizing non-functional requirements across components of a high availability cluster is disposed upon a computer readable medium, and comprises computer program instructions that, when executed, cause a computer to: receive metadata from each of a plurality of components of a high availability network cluster, the metadata indicative of a value, measured by each of the plurality of components, of one or more non-functional requirements of a service level agreement (SLA) associated with an application. The computer program instructions further cause the computer to calculate a predicted non-functional requirement using the metadata based on a model, the model being trained to determine the predicted non-functional requirement based on relationships between the metadata of each of the plurality of components; and determine a potential violation of the SLA based on a comparison of the predicted non-functional requirement and the metadata.

The foregoing and other objects, features and advantages of the disclosure will be apparent from the following more particular descriptions of exemplary embodiments of the disclosure as illustrated in the accompanying drawings wherein like reference numbers generally represent like parts of exemplary embodiments of the disclosure.

### BRIEF DESCRIPTION OF THE DRAWINGS

FIG. 1 shows a block diagram of an exemplary computing system configured for optimizing non-functional requirements across components of a high availability cluster according to embodiments of the present disclosure.

FIG. 2 shows a block diagram of interactions between a non-functional requirement (NFR) model implemented by a high availability (HA) manager and components of an HA cluster according to embodiments of the present disclosure.

FIG. 3 shows an example process for optimizing non-functional requirements across components of a high availability cluster according to embodiments of the present disclosure.

FIG. 4 is a flowchart of an example method for optimizing non-functional requirements across components of a high availability cluster according to embodiments of the present disclosure.

FIG. 5 is a flowchart of another example method for optimizing non-functional requirements across components of a high availability cluster according to embodiments of the present disclosure.

### DETAILED DESCRIPTION

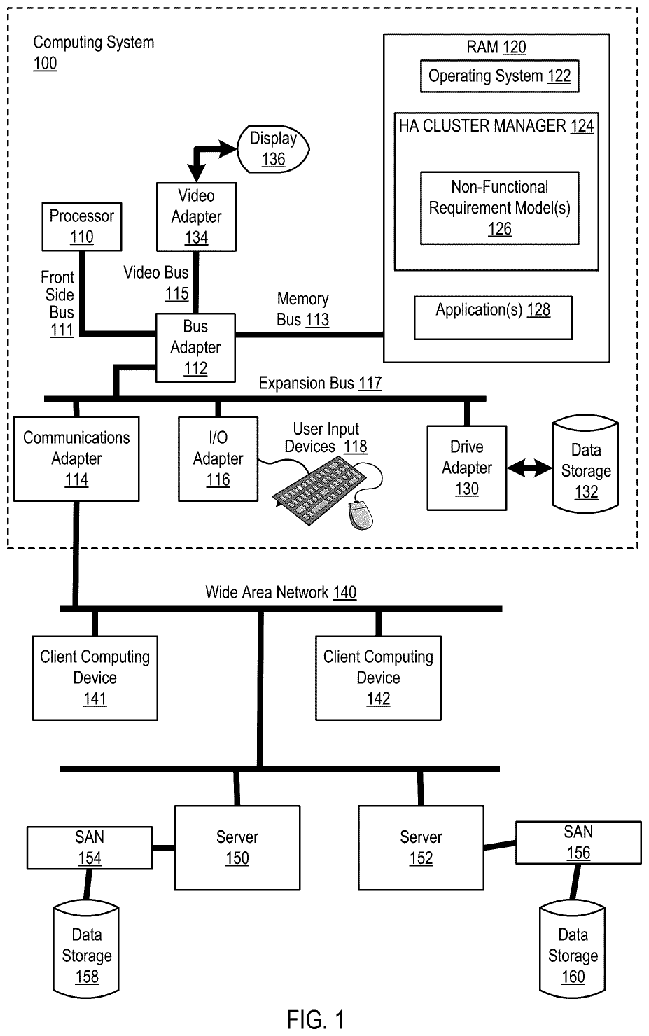

Exemplary apparatus and systems for optimizing non-functional requirements across components of a high availability cluster in accordance with the present disclosure are described with reference to the accompanying drawings, beginning with FIG. 1. FIG. 1 sets forth a block diagram of automated computing machinery comprising an exemplary computing system 100 configured for optimizing non-functional requirements across components of a high availability cluster according to embodiments of the present disclosure. The computing system 100 of FIG. 1 includes at least one computer processor 110 or ‘CPU’ as well as random access memory (‘RAM’) 120 which is connected through a high speed memory bus 113 and bus adapter 112 to processor 110 and to other components of the computing system 100.

Stored in RAM 120 is an operating system 122. Operating systems useful in computers configured for optimizing non-functional requirements across components of a high availability cluster according to embodiments of the present disclosure include UNIX™, Linux™, Microsoft Windows™, AIX™, and others as will occur to those of skill in the art. The operating system 122 in the example of FIG. 1 is shown in RAM 120, but many components of such software typically are stored in non-volatile memory also, such as, for example, on data storage 132, such as a disk drive. Also stored in RAM is a high availability (HA) cluster manager 124, including one or more non-functional requirement models 126 for optimizing non-functional requirements across components of a high availability cluster according to embodiments of the present disclosure as further described below. Also stored in RAM one or more applications 128 configured for providing services to client devices within a HA cluster according to embodiments of the present disclosure.

The computing system 100 of FIG. 1 includes disk drive adapter 130 coupled through expansion bus 117 and bus adapter 112 to processor 110 and other components of the computing system 100. Disk drive adapter 130 connects non-volatile data storage to the computing system 100 in the form of data storage 132. Disk drive adapters useful in computers configured for inserting sequence numbers into editable tables according to embodiments of the present disclosure include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computing system 100 of FIG. 1 includes one or more input/output (′I/O′) adapters 116. I/O adapters implement user-oriented input/output through, for example, software drivers and computer hardware for controlling output to display devices such as computer display screens, as well as user input from user input devices 118 such as keyboards and mice. The example computing system 100 of FIG. 1 includes a video adapter 134, which is an example of an I/O adapter specially designed for graphic output to a display device 136 such as a display screen or computer monitor. Video adapter 134 is connected to processor 110 through a high speed video bus 115, bus adapter 112, and the front side bus 111, which is also a high speed bus.

The exemplary computing system 100 of FIG. 1 includes a communications adapter 114 for data communications with other computers and for data communications with a data communications network. Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers configured for inserting sequence numbers into editable tables according to embodiments of the present disclosure include modems for wired dial-up communications, Ethernet (IEEE 802.3) adapters for wired data communications, and 802.11 adapters for wireless data communications. The communications adapter 114 of FIG. 1 is communicatively coupled to a wide area network 140 that also includes other computing devices, such as client computing devices 141 and 142 as shown in FIG. 1.

The exemplary computing system 100 of FIG. 1 includes a first server 150 and a second server 152 communicatively coupled to the wide area network 140. The first server 150 is communicatively coupled to a first server storage area network (SAN) 154. The first SAN 154 is further communicatively coupled to a data storage 158. The second server 152 is communicatively coupled to a second SAN 154, and the second SAN 156 is further communicatively coupled to a data storage 160. The first server 150 and the second server 152 are configured to function as an HA cluster to provide one or more applications to client computing devices 141 and 142. The first SAN 154 and second SAN 156 are each networks that provide access to data storage 158 and 160, respectively. In an example usage, data storage 158 and 160 are configured to store a database, and servers 150 and 152 are configured to provide access to the database to client computing devices 141 and 142.

Various embodiments described herein provide for apparatus and methods to optimize selected non-functional requirements of a HA cluster based on metadata including information and/or measurements received from active components in the data and communication paths on top of a high availability cluster. In various embodiments, the metadata is indicative of a value that represents the current fulfillment level of a particular non-functional requirement, such as latency of a transaction, associated with the component as it relates to a service level agreement (SLA) of the application. One or more embodiments utilize one or more non-functional requirement models 126 that are each configured to predict an expected non-functional requirement of an application based on a relationships between the received metadata of the components. Particular embodiments leverage the model that describes the expected non-functional requirement considering the non-functional requirement data as well as health information from the individual components. In one or more embodiments, each application of the HA cluster may have its own non-functional model 126 associated therewith.

In one or more embodiments, the first server 150 and the second server 152 implement a HA cluster and include cluster software to implement logic of an application that is executed. In one or more embodiments, the cluster software has access to all running programs and their log files, and the hardware components of the servers and their log files generated by the drivers of an operating system. If an error situation is captured, the cluster software is configured to react to the error situation by implementing redundancy operations. For some components, the redundancy is integrated into the operating system or underlying hardware components such as RAIM (Redundant Array of Independent Memory), dual ported disks, RAID (Redundant Array of independent Disks), Multipath IO, Ethernet Bonding, or Spare CPUs, which may or may not be transparent to the cluster software. If the hardware or operating system is managing the redundancy besides of additional latency, this should be transparent to the High Availability cluster. In traditional implements of HA, the cluster software normally does not have insights into components which are outside of the servers itself. Examples for these components are external Storage Arrays, SAN Switches, LAN Switches, passive or active cables between the components, or external load balancers. In situations where a degradation of the system occurs such as higher latencies for volumes of a storage than acceptable, conventional cluster software may not react. This condition is sometimes known as a “sick but not dead” situation.

Various embodiments described herein provide for an apparatus and method which is aware of the non-functional requirements of an application such as latency or bandwidth, allowing for an SLA for each component in the data flow to be derived and mitigation actions can be initiated by the apparatus and executed by the manageable components to overcome such “sick but not dead” situations. In particular embodiments, the apparatus includes the HA cluster manager 124. In various embodiments, a model is defined that describes metadata relationships which describe a measurable non-functional requirement of an application. A target non-functional requirement is derived for the application based on the metadata measured by the components involved using the model, and an SLA for the measurable target non-functional requirement is determined.

In one or more embodiments, a continuous validation of the expected non-functional requirement derived from the model against the measured target non-functional requirement is performed. In one or more embodiments, the HA cluster manager 124 communicates with the manageable components where mitigation actions can be initiated with the target to fulfil the defined SLA. Accordingly, in various embodiments, operation of the components is managed to optimize overall workloads in the case of failures.

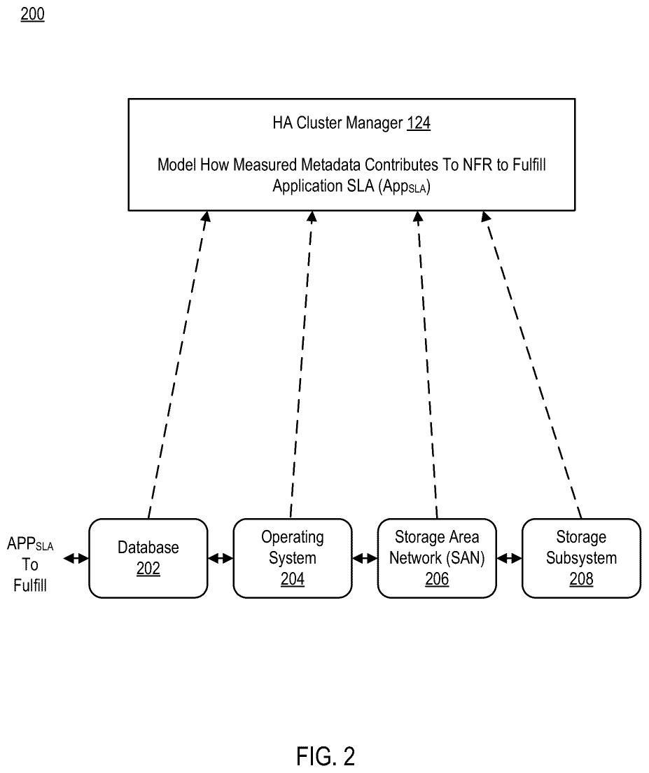

For further explanation, FIG. 2 shows a block diagram 200 of interactions between a non-functional requirement (NFR) model implemented by the HA cluster manager 124 and components of an HA cluster according to embodiments of the present disclosure. The HA manager is in communication with components of the HA cluster including a database 202, an operating system (OS), 204, a SAN 206, and a storage subsystem 208. The NFR model is configured to model relationships between metadata received from each of the components which are contributing to the NFR of an application. The NFR model is configured to model how metadata from the components contributes to an NFR to fulfill an application SLA (APP_{SLA}).

In one or more embodiments, the HA cluster manager 124 uses the model of the HA environment which includes the application in focus and all components which are used in the high availability solution. This model in conjunction with actual measurements is configured to measure the SLA of the application. In particular embodiments, an SLA calculation is performed using intuitionistic fuzzy component failure impact analysis (IFCFIA) or another suitable SLA calculation procedure. Each of the components sends metadata to the HA cluster manager 124 that is indicative of an NFR associated with the component. In particular embodiments, each component further sends health information associated with the component to the HA cluster manager 124. In an example, the database 202 sends metadata indicative of an NFR of latency for writes as well as health information associated with the database 202 to the HA cluster manager 124. In the example, the OS 204 sends metadata indicative of an NFR for latency in an I/O queue and health information associated with the OS to the HA cluster manager 124. In the example, the SAN 206 sends metadata indicative of an NFR for latency for access to a volume and health information associated with the SAN 206 to the HA cluster manager 124. In the example, the storage subsystem 208 sends metadata indicative of an NFR for latency for writes for a volume and health information associated with the storage subsystem 208 to the HA cluster manager 124.

In another example, for clarify of description metadata including one measurement and one health characteristic for each component is discussed. App_{NFR} is a non-functional requirement such as latency that should be covered with an SLA, and App_{SLA} is an SLA of the application which should be provided for the NFR. An example of App_{SLA} is that 99% of transactions should be lower than 1 ms within 1 minute.

In the example, the components of the HA cluster include:
Server1_{Health}=Health Status of Server1
Server2_{Health}=Health Status of Server2
OS1_{Health}=Health Status of OS1
OS1_{FCLatency}=FC Latency OS1
OS2_{Health}=Health Status of OS2
OS2_{FCLatency}=FC Latency OS2
Storage1_{Health}=Health Status of Storage 1
Storage1_{WriteLatency}=Write Latency Storage1
Storage2_{Health}=Health Status of Storage2
Storage2_{WriteLatency}=Write Latency Storage2
SAN1_{Health}=Health of SAN1
SAN2_{Health}=Health of SAN2

In the example, these measurements are constantly evaluated and are gathered by the HA cluster manager 124. The NFR model is fed these measurements and predicts a value for the NFR (P_{NFR}=predicted NFR) which is relied upon for the SLA monitoring. During normal operation, the prediction of the model P_{NFR} is checked against App_{SLA}. As long as the App_{SLA} is not violated, normal monitoring continues. As soon as the App_{SLA} is violated, mitigation actions are evaluated. Using the health data of all of the components and the metadata indicative of the measurements of the contributing factors, such as I/O latencies, the model detects which component is showing a deviation from normal behavior and evaluates potential mitigation actions using the model.

For storage subsystems a common source for excessive latencies is a rebuild triggered by a failing drive. Assume that Storage Subsystem 1 has an issue and indicates this in Storage1Health and the Measurement of Storage1_{Readlatency} and OS1_{FCLatency} show an abnormal high value. The HA cluster manager 124 uses the model to determine what improvement is needed to bring the application in the HA solution back into the desired SLA.

In a first approach, without breaking the HA environment or redundancies, the model evaluates mitigations which may be either in the component having the issue or other components. Example mitigation options include redirecting all read I/Os to the not affected Storage Subsystem 2 by reconfiguring the multipath I/O configuration within the OS1, and changing a rebuild rate in the affected storage Subsystem 1 to decrease the rebuild impact and release I/O and CPU stress of the array and enhancing the latency for the application. Further example mitigation options include prioritizing an important workload which has SLA imposed by throttling other workloads which are marked as non-productive, or terminate workloads that are tagged as victims on the Storage Subsystem 1. Another example mitigation option includes dynamically increasing an I/O cache of the application to reduce the read I/Os issued against the storage. All of these example mitigation actions can then be applied to the model. For all of the mitigation actions the model assesses the expected improvements in the predicted P_{NFR}. In a particular embodiment, the expected results P_{NFR} indicated by the model for each mitigation option are ranked in relation to the improvement of the expected App_{NFR} and if other applications are affected due to changes in shared components. Having a ranked list of options, the HA cluster manager 124 executes one mitigation after the other and records the achieved App_{NFR}. If the App_{NFR} is within the expected App_{SLA} the process of mitigation ends. As soon as the measured Storage1_{Readlatency} and OS1_{FCLatency} return to a normal level and Storage1_{Health} is also cleared, the HA cluster manager 124 reconfigures the HA environment to the default values.

In a second approach, if the non-redundancy breaking mitigations did not bring the application back into the SLA, the HA cluster manager 124 evaluates mitigations which would break the redundancies. In particular embodiments, a user may choose which mitigations are to be performed. Example mitigation options include redirecting all I/Os to the non-affected Storage Subsystem 2 by reconfiguring the mirroring of data in the OS1, blocking all I/Os to the Storage Subsystem 1 using SAN switches of the SAN1 and forcing the mirroring of the OS1 to fail the volumes from Storage Subsystem 1, or blocking all I/Os to the respective volumes within Storage Subsystem 1.

In one or more embodiments, the process runs in a continuous cycle, so in a case in which one mitigation action is taken that results in a decrease of the expected SLA or makes the functioning worse than the previous measurement, the HA cluster manager 124 will either revert the previous mitigation or try a new one. Based on tracking the actions taken and measurements, the HA cluster manager 124 may decide that the better action is not taking an action but wait for the causing factor to end.

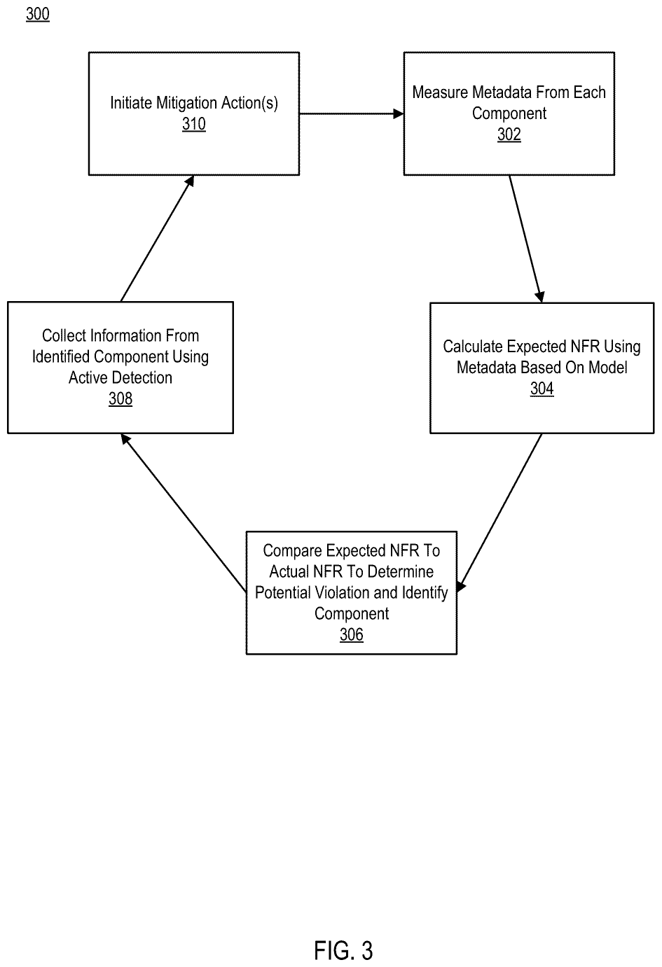

FIG. 3 shows an example process 300 for optimizing non-functional requirements across components of a high availability cluster according to embodiments of the present disclosure. In 302, measurement of the metadata by each of the components is performed and the individual components report their respective fulfillment against the model to the HA cluster manager 124. In 304, the HA manager calculates an expected NFR using the metadata based on the model. In 306, the HA cluster manager 124 compares the expected NFR to the actual NFR and determines if a potential violation of the SLA occurs, and identifies the component or components contributing to the potential violation. In a particular embodiment, the HA cluster manager 124 determines that a potential violation occurs is a comparison between the expected NFR and the actual NFR determines that a difference between the expected NFR and the actual NFR is greater than a threshold value.

In 308, the HA cluster manager 124 collects information from the identified component using active detection to determine if the issue is with the component or, for example, due to a load. In 310, the HA cluster manager 124 initiates one or more mitigation actions and returns to 302. Accordingly, the process 300 is a continuous process in which potential violation of the SLA is continually evaluated.

In a particular embodiment, the HA cluster manager 124 initiates mitigation actions by sending requests to all components which could improve the SLA. Using the model, the HA cluster manager 124 determines which improvement has to be achieved in which individual component to be able to fulfill the SLA. In particular embodiments, the mitigation activities initiated by the apparatus in the components can be grouped into two categories. For non-manageable components such as cables, non-managed switches, etc., a failover to a redundant component is actively initiated. For manageable components, a mitigation action is initiated if the model predicts better fulfillment of the SLA.

As an example, active mitigation actions in a storage subsystem include:
If the storage subsystem is experiencing a rebuild, the rebuild speed is reduced.
If the storage subsystem is handling workloads with lower SLAs, these workloads are throttled.
If the storage subsystem has issues on one redundant connection (e.g., FC Errors, or dropped frames) the connection is disabled.
If multiple volumes are served on the same connection such as the volume with the SLA, the I/Os for the other volumes are redirected to redundant paths.
A storage tiering to lower latency storage is initiated.

As another example, active mitigation actions in a virtual machine (VM) include:
Requesting more virtual CPUs.
Requesting more memory.
Requesting higher priority in the virtualization environment.

As another example, active mitigation actions in a database include:
Using more cache
Creating indices
Altering SQL strategies

In one or more embodiments, due to the communication between the component and the HA cluster manager 124, a message is sent by the component which it is not able to fulfill the SLA requested by the HA cluster manager 124. In this way, the HA cluster manager 124 is able to fail over to a redundant component and recover safely.

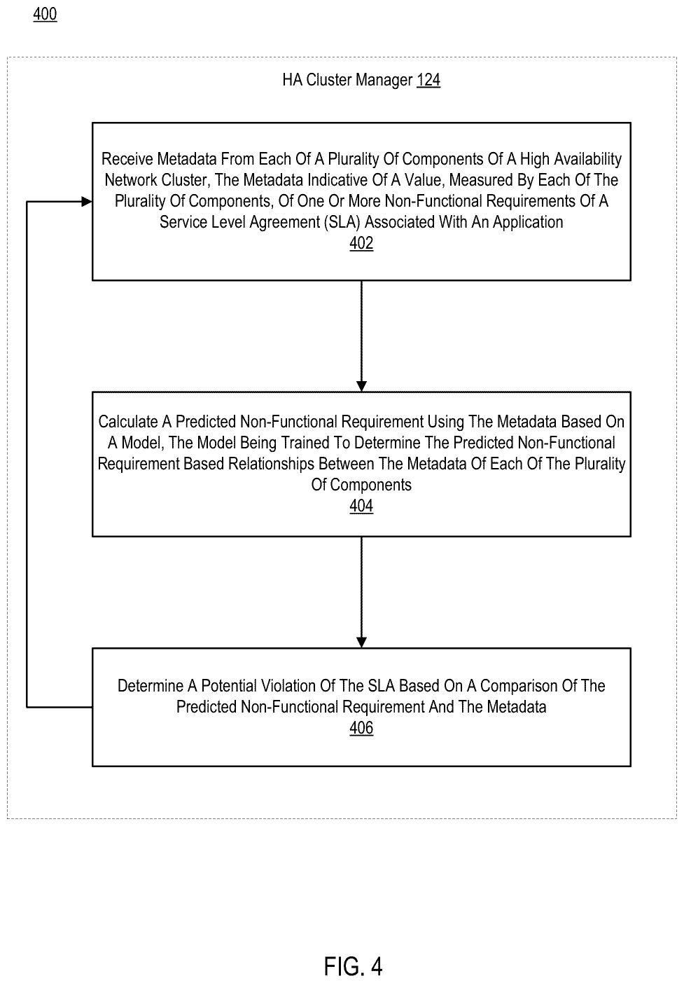

For further explanation, FIG. 4 is a flowchart of an example method 400 for optimizing non-functional requirements across components of a high availability cluster according to embodiments of the present disclosure. The method 400 of FIG. 4 includes receiving 402 metadata from each of a plurality of components of a high availability network cluster. The metadata is indicative of a value, measured by each of the plurality of components, of one or more non-functional requirements of a service level agreement (SLA) associated with an application. In some embodiments, the metadata further includes a health status associated with each of the plurality of components. In some embodiments, the one or more non-functional requirements includes one or more of a latency or bandwidth associated with each of the plurality of components. In some embodiments, the one or more components include at least one of a database, a server, an operating system component, a storage area network (SAN), and a storage subsystem.

The method 400 further includes calculating 404 a predicted non-functional requirement using the metadata based on a model. The model is trained to determine the predicted non-functional requirement based on relationships between the metadata of each of the plurality of components. The method 400 further includes determining 406 a potential violation of the SLA based on a comparison of the predicted non-functional requirement and the metadata. The method 400 then returns to 402.

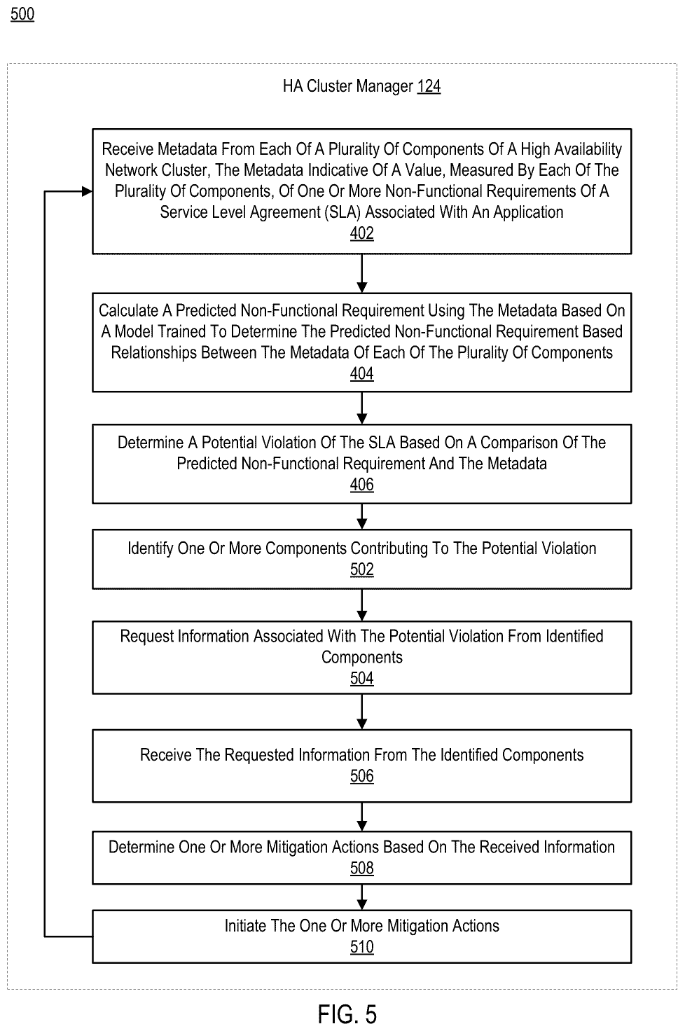

For further explanation, FIG. 5 is a flowchart of another example method 500 for optimizing non-functional requirements across components of a high availability cluster according to embodiments of the present disclosure. The method 500 of FIG. 5 continues with the method of FIG. 4 by further including identifying 502 one or more components of the plurality of components contributing to the potential violation. The method 500 further includes requesting 504 information associated with the potential violation from the one or more identified components, receiving 506 the requested information from the one or more identified components, and determining 508 one or more mitigation actions based on the received information.

The method 500 further includes initiating 510 the one or more mitigation actions. In some embodiments, initiating the one or more mitigation actions includes sending a request to one or more of the plurality of components to modify an operation of the component to improve fulfillment of the SLA.

In some embodiments, the method 500 further includes determining an expected improvement to the predicted non-functional requirement for each of the one or more mitigation actions using the model, and ranking the one or more mitigation actions based on the respective expected improvement to the predicted non-functional requirement. In some embodiments, the method 500 further includes selecting one of the mitigation actions based on the ranking, and initiating the selected mitigation action.

In view of the explanations set forth above, readers will recognize that the benefits of optimizing non-functional requirements across components of a high availability cluster according to embodiments of the present disclosure include:
Improved fulfillment of application SLAs in a high-availability cluster environment.
Automated switching to redundant components in a high-availability cluster environment in case of “sick but not dead” situations.

Exemplary embodiments of the present disclosure are described largely in the context of a fully functional computer system for optimizing non-functional requirements across components of a high availability cluster. Readers of skill in the art will recognize, however, that the present disclosure also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the disclosure as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. A method for optimizing non-functional requirements across components of a high availability cluster, the method comprising:
receiving metadata from each of a plurality of components of a high availability network cluster, the metadata indicative of a value, measured by each of the plurality of components, of one or more non-functional requirements of a service level agreement (SLA) associated with an application;
calculating a predicted non-functional requirement using the metadata based on a model, the model being trained to determine the predicted non-functional requirement based on relationships between the metadata of each of the plurality of components; and
determining a potential violation of the SLA based on a comparison of the predicted non-functional requirement and the metadata.

2. The method of claim 1, further comprising:
identifying one or more components of the plurality of components contributing to the potential violation.

3. The method of claim 2, further comprising;
requesting information associated with the potential violation from the one or more identified components;
receiving the requested information from the one or more identified components; and
determining one or more mitigation actions based on the received information.

4. The method of claim 3, further comprising initiating the one or more mitigation actions.

5. The method of claim 4, wherein initiating the one or more mitigation actions comprises sending a request to one or more of the plurality of components to modify an operation of the component to improve fulfillment of the SLA.

6. The method of claim 3, further comprising:
determining an expected improvement to the predicted non-functional requirement for each of the one or more mitigation actions using the model;
ranking the one or more mitigation actions based on the respective expected improvement to the predicted non-functional requirement;
selecting one of the mitigation actions based on the ranking; and
initiating the selected mitigation action.

7. The method of claim 1, wherein the metadata further includes a health status associated with each of the plurality of components.

8. The method of claim 1, wherein the one or more non-functional requirements includes one or more of a latency or bandwidth associated with each of the plurality of components.

9. The method of claim 1, wherein the one or more components include at least one of a database, a server, an operating system component, a storage area network (SAN), and a storage subsystem.

10. An apparatus for optimizing non-functional requirements across components of a high availability cluster, the apparatus comprising:
a computer processor; and
a computer memory operatively coupled to the computer processor, the computer memory having disposed therein computer program instructions that, when executed by the computer processor, cause the apparatus to:
receive metadata from each of a plurality of components of a high availability network cluster, the metadata indicative of a value, measured by each of the plurality of components, of one or more non-functional requirements of a service level agreement (SLA) associated with an application;
calculate a predicted non-functional requirement using the metadata based on a model, the model being trained to determine the predicted non-functional requirement based on relationships between the metadata of each of the plurality of components; and
determine a potential violation of the SLA based on a comparison of the predicted non-functional requirement and the metadata.

11. The apparatus of claim 10, wherein the apparatus is further configured to identify one or more components of the plurality of components contributing to the potential violation.

12. The apparatus of claim 11, wherein the apparatus is further configured to:
request information associated with the potential violation from the one or more identified components;
receive the requested information from the one or more identified components; and
determine one or more mitigation actions based on the received information.

13. The apparatus of claim 12, wherein the apparatus is further configured to initiate the one or more mitigation actions.

14. The apparatus of claim 13, wherein initiating the one or more mitigation actions comprises sending a request to one or more of the plurality of components to modify an operation of the component to improve fulfillment of the SLA.

15. The apparatus of claim 12, wherein the apparatus is further configured to:
determine an expected improvement to the predicted non-functional requirement for each of the one or more mitigation actions using the model;
rank the one or more mitigation actions based on the respective expected improvement to the predicted non-functional requirement;
select one of the mitigation actions based on the ranking; and
initiate the selected mitigation action.

16. The apparatus of claim 10, wherein the metadata further includes a health status associated with each of the plurality of components.

17. The apparatus of claim 10, wherein the one or more non-functional requirements includes one or more of a latency or bandwidth associated with each of the plurality of components.

18. A computer program product for optimizing non-functional requirements across components of a high availability cluster, the computer program product disposed upon a computer readable medium, the computer program product comprising computer program instructions that, when executed, cause a computer to:
receive metadata from each of a plurality of components of a high availability network cluster, the metadata indicative of a value, measured by each of the plurality of components, of one or more non-functional requirements of a service level agreement (SLA) associated with an application;
calculate a predicted non-functional requirement using the metadata based on a model, the model being trained to determine the predicted non-functional requirement based on relationships between the metadata of each of the plurality of components; and
determine a potential violation of the SLA based on a comparison of the predicted non-functional requirement and the metadata.

19. The computer program product of claim 18, wherein the instructions further cause the computer to identify one or more components of the plurality of components contributing to the potential violation.

20. The computer program product of claim 19, wherein the instructions further cause the computer to:
request information associated with the potential violation from the one or more identified components;
receive the requested information from the one or more identified components; and
determine one or more mitigation actions based on the received information.
